(19) United States
(12) Patent Application Publication
(10) Pub. No.: US 2014/0325941 A1
(43) Pub. Date: Nov. 6, 2014

(54) METHOD AND APPARATUS FOR PRODUCING BEVERAGE CONTAINERS FILLED WITH LIQUIDS

(71) Applicants: Josef Knott, Walkenstetten/Schierling (DE); Hans Scheuren, Regensburg (DE)

(72) Inventors: Josef Knott, Walkenstetten/Schierling (DE); Hans Scheuren, Regensburg (DE)

(21) Appl. No.: 14/131,401

(22) PCT Filed: Jun. 28, 2012
(86) PCT No.: PCT/EP2012/062627

§ 371 Date: Feb. 7, 2014

(30) Foreign Application Priority Data
Jul. 15, 2011 (DE) 10 2011 107 772.7

(51) Int. Cl. B65B 55/02; B65B 47/02; B67C 7/00; B65B 55/08; B65B 55/10

(52) U.S. Cl. CPC B65B 55/027; B65B 55/08; B65B 55/10; B67C 7/00; B65B 47/02
USPC 53/426; 53/167

(57) ABSTRACT

The method for producing containers filled with liquids, and in particular with beverages, wherein plastic preforms are heated by a heating device, are then transported to a shaping device and are shaped by this shaping device to form the plastic containers, and the plastic containers are then transported to a filling device and filled with the liquid, and wherein the containers are transported inside a clean room at least during the filling and, before being filled with the liquid inside the clean room, they are at least in part sterilized by a first sterilizing device. According to the invention, before being sterilized by means of the first sterilizing device, the plastic containers are pre-sterilized by means of a second sterilizing device, wherein this pre-sterilization is performed outside the clean room.

The present invention relates to an apparatus and a method for producing beverage containers filled with liquid, in particular with a beverage. Methods of this type have been known from the prior art for a relatively long time. In this way, for example, apparatus and methods are known in which a blow moulding station or a shaping device respectively first produced plastics material containers from plastics material pre-forms and these containers are then filled with a liquid, such as for example a beverage.

EP 21 38 298 A2 describes an apparatus and a method for producing plastics material containers. In this case the plastics material pre-forms are first sterilized with a first sterilization device, are then heated and shaped and after their shaping as plastics material containers they are sterilized with a second sterilization device. In this case the two sterilization devices are used to carry out a total sterilization of the containers in an effective manner. This apparatus, however, requires a housing or a clean room respectively which surrounds the entire apparatus including the furnace, the shaping stations and also the filling devices. It is relatively complicated in this case to maintain the sterile conditions inside a large clean room of this type.

An apparatus and a method for sterilizing plastics material pre-forms are known from WO 2010/020530 A1. In this case it is provided that after the end of a heating procedure of the plastics material pre-forms and before the end of the shaping procedure in the shaping device the sterilization of the containers is already taking place by means of a flowable medium, for example H₂O₂, peracetic acid or ClO₂. With this apparatus, however, there is the risk that recontamination of the plastics material pre-forms can occur.

EP 1 98 2 920 A1 describes an apparatus for the sterilization of containers. In this case treatment heads are introduced into the container through an aperture in the latter and the inner wall of the containers is treated with electron radiation in order to sterilize this internal surface. The contents of the disclosure of EP 1 98 2 920 A1 are hereby also made the contents of the disclosure of the present application by reference in its entirety.

The object of the present invention is therefore to simplify the sterilization of containers of this type. In this way, an increase in efficiency of existing and future aseptic plants is to be achieved. These objects are attained by a method and an apparatus according to the independent claims. Advantageous embodiments and further developments form the subject matter of the sub-claims.

In the case of a method according to the invention for producing containers filled with liquids, and in particular with beverages, plastics material pre-forms are heated by a heating device, are conveyed after that to a shaping device and are shaped by this shaping device to form the plastics material containers. After that, the plastics material containers are conveyed to a filling device and are filled with the liquid. In this case the containers are conveyed inside a clean room at least during the filling and are sterilized by a first sterilization device at least in part before the filling with the liquid inside the clean room.

According to the invention the plastics material containers are pre-sterilized by means of a second sterilization device before the sterilization by the first sterilization device, this pre-sterilization being carried out outside the clean room.

It is therefore proposed that a pre-sterilization of the containers should be carried out outside the clean room. It is therefore advantageous for this pre-sterilization to be carried out under non-sterile environmental conditions. Although it does not seem logical at first sight for a sterilization to be carried out under non-sterile conditions since it is necessary to reckon with a certain degree of recontamination of the containers, it is nevertheless proposed according to the invention that this pre-sterilization should be a process which achieves only a certain level of cleanness of the plastics material containers. In this way, the sterilization which takes place later can be carried out with a lower outlay since the degree of cleanness of the containers is already higher than if these had not been pre-sterilized.

In this case the containers are preferably sterilized after the shaping by the first sterilization device. It is therefore advantageous for the containers to be sterilized already during the shaping process inside the clean room. In the case of a further advantageous method the pre-sterilization with the second sterilization device is carried out after the heating with the heating device. In this way, the plastics material pre-forms are advantageously conveyed outside the clean room during the heating.

It is advantageous for the pre-sterilization to be carried out in such a way that an inner wall of the plastics material containers is acted upon with radiation and/or charge carriers.

It is thus proposed within the scope of the invention to supplement an aseptic sterilization unit, in particular a sterilization unit operating chemically, with a sterilization unit operating physically. This further sterilization unit is not necessary in this case and is preferably not designed in the form of an aseptic sterilization unit. It would be possible in this case for the inner wall of the containers to be acted upon with radiation such as UV radiation or laser radiation, X-ray radiation or the like. It is preferable, however, for the inner wall of the containers to be acted upon with electron radiation or electrons respectively. In this way, it is advantageous for the use of electron beams to be provided for the internal treatment of the plastics material containers. In this case it would be possible for the plastics material pre-forms to be acted upon with electron beams or other beams or only the finished plastics material containers. This is advantageously carried out outside the clean room.

On account of the procedure according to the invention it is therefore possible to design the clean room smaller, and this also has a direct effect upon the outlay for maintaining sterile conditions.

A suitable plant for the irradiation of the plastics material containers reduces the germ burden by irradiation of the inner side of the containers, in such a way that for example only one in a million pre-forms (log 6) is germ-laden. These semi-finished containers are shaped or blow moulded respectively in the following blow moulding machine. As a result of this process as well as the asepsis possibly not yet present in this portion a re-infection takes place, so that then one in 1000 pre-forms (−log 3) is again germ-laden. After that, the actual sterilization is carried out by the use of chemical agents with a germ reduction of log 4. Finally, the containers produced in this way are filled with a liquid, for example a low-acid product.

It is advantageous for the plastics material containers to be sterilized by means of the first sterilization device by being acted upon with a flowable sterilization medium. In this case for example peracetic acid or hydrogen peroxide (H₂O₂) are possible as the sterilization medium.

In this way, there is a definite link of the chemical and physical sterilization. As mentioned, it is possible for a sterilization first to be carried out by stressing with radiation and/or charge carriers and this is advantageously carried out outside the clean room and a chemical sterilization then follows in the interior of the clean room. In addition to or instead of a radiation with charge carriers it would also be possible for an irradiation by means of UV light to be provided here.

Conversely, however, it would also be possible for a chemical sterilization, preferably acting upon the containers with peracetic acid or hydrogen peroxide, first to be carried out, for example outside the clean room, and for this to be followed by a further sterilization by acting upon the containers with radiation and/or charge carriers, in particular in the interior of the clean room.

In this case it would also be possible for a pre-sterilization with a chemical medium first to take place and then—since the containers already have a certain degree of cleanness—for a sterilization by stressing with UV light to take place as the second sterilization. As a result, costs can also be saved, since a sterilization by means of UV radiation can be carried out more inexpensively than a stressing with charge carriers such as electrons.

It is preferable for a definite link of aseptic and septic sterilization to be carried out, in which case in particular the stressing with the sterilization medium takes place under aseptic conditions (i.e. for example inside a clean room).

As a whole an increased reliability of the process is achieved by the proposed procedure, since essentially every germ can be destroyed. A reduction in the use of chemical agents is also possible for the apparatus since already irradiated plastics material containers require less use of sterilization. In addition, an increase in the performance of the aseptic sterilization unit can also be achieved in this way, since as well as the reduced use of chemical agents the treatment time in the aseptic sterilization unit can also be reduced. A combination of a chemical sterilization with a physical sterilization unit which for example acts upon the plastics material containers with radiation or charge carriers is therefore proposed in a particular preferred manner. It is therefore preferable for the second sterilization device, which sterilizes the plastics material containers by acting upon them with radiation and/or charge carriers, to be arranged upstream of the first sterilization device in the conveying direction of the containers.

In the case of a further advantageous method the plastics material pre-forms are pre-sterilized with the second sterilization device before and/or during the shaping procedure. In the case of this procedure, therefore, the plastics material pre-forms are already sterilized, and this can be advantageous inasmuch as they have a substantially smaller surface than the plastics material containers substantially shaped from them. It would also be possible, however, for the pre-sterilization, also referred to below as physical treatment, to take place directly before the following chemical treatment after the actual shaping procedure. In addition, it would be possible for an irradiation of the plastics material pre-forms also to be capable of being carried out before a chemical treatment upstream of a sterile blow moulding machine. This means that it would be possible for the plastics material pre-forms first to be pre-sterilized by irradiation and directly afterwards to be sterilized by being acted upon with the flowable medium and only after that to be shaped by the shaping device.

In the case of a further advantageous method an inner wall of the plastics material pre-forms is exclusively sterilized by means of the second sterilization device.

This can be carried out for example by radiation fingers dipping into the interior of the plastics material pre-forms or plastics material containers and for the inner wall to be acted upon accordingly with radiation and/or radiation carriers. In addition, however, an aperture region of the plastics material pre-forms can also be sterilized by means of a second sterilization device.

In the case of a further advantageous method the plastics material containers are conveyed at least in sections inside a clean room, in which case the plastics material pre-forms are still conveyed outside the clean room at least during their heating. It is therefore proposed that the clean room should be made smaller as compared with the prior art and, in particular, that the heating of the plastics material pre-forms should be carried out upstream of the clean room. It is therefore advantageous for the sterilization with the second sterilization device also to take place outside the clean room, whereas the sterilization with the first sterilization device is carried out inside the aforesaid clean room. In this case it is possible for the shaping procedure of the plastics material pre-forms into the plastics material containers to take place already inside a clean room.

The present invention further relates to an apparatus for producing containers filled with liquid, this apparatus having a heating device which heats plastics material pre-forms, as well as a shaping device which is arranged downstream of the aforesaid heating device in a conveying direction of the plastics material pre-forms and which shapes the plastics material pre-forms into plastics material containers. Furthermore, the apparatus has a filling device which is arranged downstream of the shaping device in a conveying direction of the plastics material containers and which fills the containers with a liquid, and in particular with a beverage. Furthermore, the apparatus has a clean room in which the containers are treated at least in part, and in particular are filled. In addition, a first sterilization device is provided, which is arranged at least in part upstream of the filling device and inside the clean room and which sterilizes the plastics material containers.

According to the invention the apparatus has a second sterilization device which pre-sterilizes the plastics material containers, this second sterilization device being situated outside the clean room.

It is therefore also proposed with respect to the apparatus that a pre-sterilization of the containers should be carried out outside the clean room. It is advantageous for the second sterilization device to be arranged upstream of the clean room in the conveying direction of the containers.

It is advantageous for this second sterilization device to be arranged downstream of the heating device in the conveying direction of the containers. It is advantageous for the second sterilization device to be arranged upstream with respect to the shaping device in the conveying direction of the plastics material containers. In the case of a further advantageous embodiment the first sterilization device is provided between the shaping device and the filling device. It would also be possible, however, for the first sterilization device to be arranged upstream of the shaping device. It is preferable for the first sterilization device as a whole to be arranged upstream of the filling device.

It is advantageous for the shaping device to be a blow moulding machine, and in particular a stretch blow moulding machine. This means that this shaping device advantageously has a plurality of blow moulding stations which are arranged on a movable carrier, and in particular on a rotatable carrier wheel. In addition, these individual blow moulding stations also advantageously have stretch rods which stretch the plastics material containers in their longitudinal direction. The heating device can be designed in this case in the form of an infrared furnace in which the plastics material pre-forms are heated during the conveying thereof. It would also be possible, however, for the heating to be in the form of a microwave heating device, which in a particularly preferred manner has a plurality of heating units in which the plastics material pre-forms are heated by being acted upon with microwaves.

In the case of a further advantageous embodiment the filling device also has a plurality of filling elements which are arranged on a movable carrier, and in particular on a rotatable filling wheel. It is advantageous for the apparatus further to have a clean room which surrounds at least components of the apparatus, such as for example the filling device. It is advantageous for this clean room also to surround at least in sections the conveying path on which the plastics material pre-forms are conveyed during the shaping procedure.

It is advantageous for the clean room to surround this conveying path in the manner of a duct. In this way, the apparatus has a conveying device for conveying the plastics material containers.

In the case of a further advantageous embodiment the second sterilization device has a stressing device which acts upon at least an inner wall of the plastics material pre-forms with charge carriers and/or magnetic radiation. It is advantageous for the second sterilization device further to have a movable carrier, on which are arranged a plurality of stressing devices which act upon at least an inner wall of the plastics material pre-forms with charge carriers and/or electrical radiation. It is advantageous for this to be a rotatable carrier.

In the case of a further advantageous embodiment the aforesaid stressing device is movable with respect to the plastics material pre-forms or the plastics material containers respectively in a direction which deviates from the conveying path of the plastics material pre-forms. In this case it is possible for the stressing device itself to be moved in the aforesaid direction, but in order to achieve this relative movement it is advantageous for the plastics material pre-forms to be moved and for the stressing devices to be kept stationary at least in this direction of movement. It is advantageous for the aforesaid direction to be a direction extending at a right angle to the conveying path.

In the case of a further advantageous embodiment at least one stressing device is capable of being inserted into the plastics material pre-forms at least in sections through an aperture of the latter.

Further advantageous embodiments are evident from the accompanying drawings. In the drawings

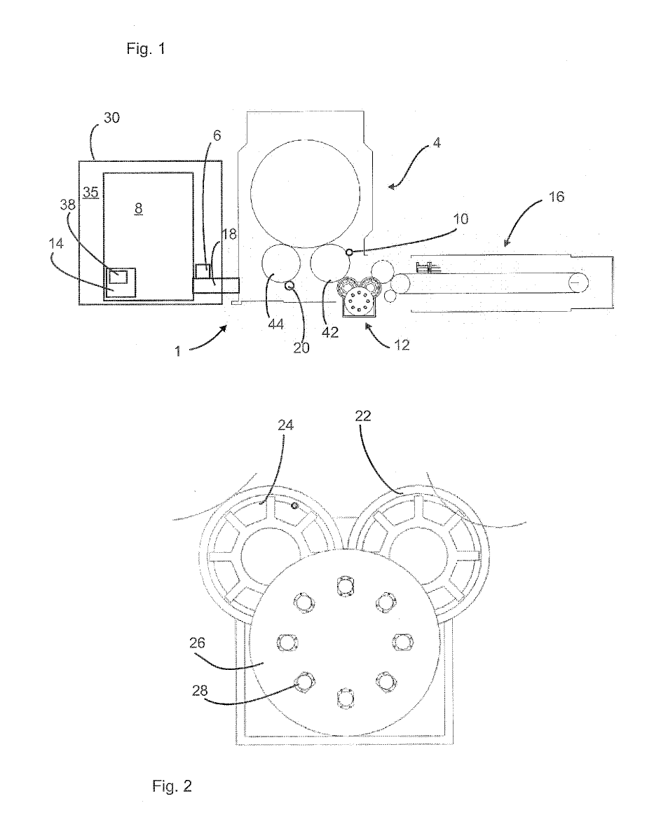

FIG. 1 is a diagrammatic illustration of an apparatus according to the invention;

FIG. 2 is a plan view of a second sterilization device;

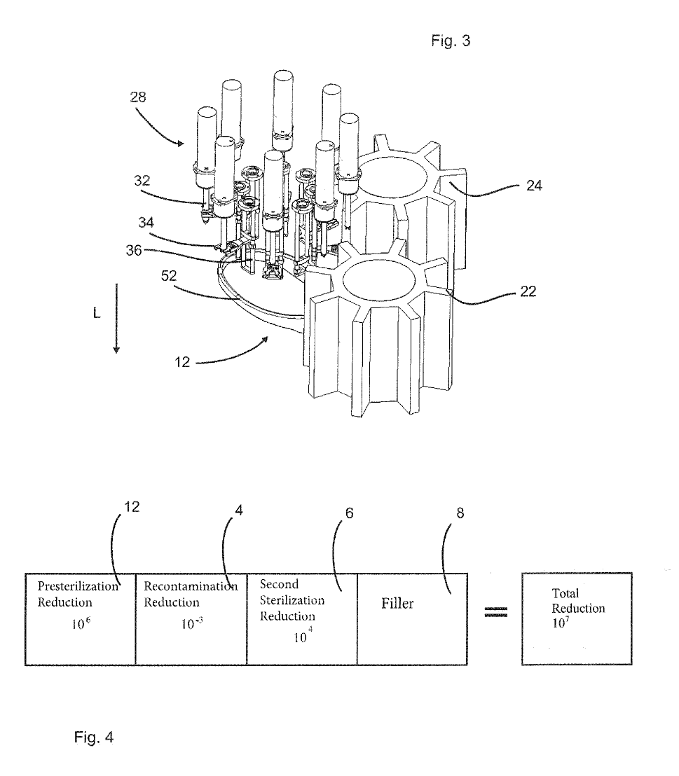

FIG. 3 is a further view of a second sterilization device, and

FIG. 4 is an illustration to explain the sterilization of the containers.

FIG. 1 is a diagrammatic illustration of an apparatus for the treatment of containers. In this case plastics material pre-forms 10 are first heated in a heating device 16 and are then shaped by a shaping device 4 to form plastics material containers 20. After that, these plastics material containers 20 are conveyed to a filling device 8 by means of a conveying device 18 and there they are filled with a liquid, and in particular a beverage. The reference number 6 shows diagrammatically a first sterilization device which sterilizes the containers which are not yet, however, filled. This sterilization can be carried out in particular in this case by stressing with a sterilization medium, i.e. in a chemical manner.

The reference number 30 refers to a housing which surrounds at least the filling device 8 and the first sterilization device 6. A clean room 35 is formed in the interior of this housing 30. In this way, the sterilization with the first sterilization device 6 is already carried out under sterile or aseptic conditions.

The filling procedure 8 is also carried out under aseptic conditions.

The reference number 14 refers to an illustrated (only diagrammatically) closing device which closes the containers with closures. In addition, the closing device can also be arranged in this case in the clean room 35. In this case a third sterilization device 38 can be provided which sterilizes the container closures (in particular under aseptic conditions, i.e. in particular inside a clean room).

The reference number 42 refers to a supply wheel which supplies the plastics material pre-forms to the shaping device 4 and the reference number 44 refers to a removal wheel or a run-out star wheel respectively which removes the plastics material containers 20. The reference number 12 designates the second sterilization device which sterilizes the plastics material pre-forms before the entry thereof into the shaping device 4. In this case the second sterilization device preferably sterilizes the plastics material pre-forms in a physical manner, i.e. by acting upon them with radiation and/or (preferably) charge carriers. This second sterilization device is arranged outside the clean room 35. In this way, the clean room can be designed to be comparatively small. In the case of the embodiment shown here the shaping procedure still takes place outside the clean room.

It would also be possible and preferable, however, for the shaping procedure to take place already under sterile conditions or for the shaping device 4 to be situated at least in part inside the clean room. In this case it is possible for at least the individual shaping stations of the shaping device to be arranged inside the clean room or to be conveyed inside the clean room. In addition, it would be possible for a plurality of clean rooms to be provided which for example are connected to one another by means of air locks or the like.

The use—proposed here—of a unit which sterilizes purely physically provides a number of advantages in comparison. On the one hand it is possible for germs which are not destroyed by chemical agents to be destroyed by the aforesaid radiation or the electron radiation respectively. In addition, it is also possible for the performance of the plant as a whole not to be reduced despite the additional unit or the second sterilization device 12 respectively. In addition, the proposed sterilization device 12 is also relatively inexpensive to produce and maintain and, finally, the sterilization effect is based on electrical current.

In this way, the use of chemicals of the following aseptic sterilization unit 6 can also be reduced. Furthermore, it is possible in this way for the process times and thus also the magnitude of the sterilizer or the clean room 35 respectively to be reduced. In addition, any formation of smell or discoloration can also be intercepted by the use of charge carriers by the following treatment steps. In this way, an improvement of sterilization processes of this type is achieved by the enlargement of a conventional chemical sterilization apparatus 6 by a physical disinfection process. It is advantageous in this case for the second sterilization device 12 not to operate aseptically, in which case—as mentioned above—the advantages set out above are achieved just by the combination of the two methods, i.e. the chemical and the physical sterilization.

FIG. 2 is a plan view of a second sterilization unit 12. This likewise has in this case a supply wheel 22 which supplies the plastics material pre-forms as well as a removal wheel 24 which removes the pre-sterilized plastics material pre-forms. A plurality of stressing devices 28, for example the radiation fingers mentioned above which dip into the interior of the containers, are arranged on the movable, and in particular rotatable, carrier 26. In this way, it is preferably possible for the second sterilization device 12 to have between four and twelve, and preferably between six and ten, stressing devices for the internal treatment of the containers. The rotatable carrier 26 can in this case have a reference circle with a diameter of between 400 mm and 600 mm, preferably between 500 mm and 550 mm depending upon the power.

FIG. 3 is a further illustration of a second sterilization device 12. The stressing devices are like-wise in this case designated 28 as a whole and have in each case a radiation finger 32 which can be introduced into a container. For this purpose the apparatus has gripping elements 34 which grip the containers or the plastics material pre-forms respectively for example below the carrying ring thereof and lift them upwards, so that the radiation fingers 32 can dip into the interior of the containers. In addition, the gripping elements 34 can be arranged on a carrier 36 which permits a displacement in the direction L which at the same time is also a longitudinal direction of the plastics material pre-forms. The reference number 52 refers to a guide cam which is arranged in a stationary manner and which permits the lifting and lowering of the plastics material pre-forms or the gripping elements respectively. In this way, a mechanical stroke of the plastics material pre-forms thus takes place, but in order to perform this stroke it is also possible for use to be made of other drive devices, such as for example servo motors, hydraulic or pneumatic drives and the like. It is advantageous for the individual radiation devices or stressing devices 28 respectively to be air-cooled or gas-cooled respectively, this cooling advantageously being used for the cooling for an outlet window of the electrons.

In principle it would also be possible for the second sterilization device 12 to be arranged already upstream of the heating apparatus shown in FIG. 1, i.e. the furnace. In this case the supply and removal star wheels 22 and 24 can already be enclosed for the purpose of screening. As mentioned, instead of or in addition to the plastics material pre-forms, the already finished blow moulded plastics material containers can be sterilized by being acting upon with electron (radiation). Furthermore, it would be possible in addition (optionally with a further unit) to achieve an external treatment of the plastics material pre-forms or plastics material containers by acting upon them with electrons or general charge carriers. The sterilization device 12 could also be situated as a whole in a housing.

FIG. 4 shows a possible course for a sterilization according to the invention. In this case a reduction in the germs by the factor of 10⁶ is first achieved with the aid of the second sterilization device 12. After that, re-contamination usually occurs in the blow moulding machine, the re-contamination being achieved again, after that, by the factor of 10⁴ by the further germ-reduced first sterilization device 6. Finally the containers are filled by the filling device 8. In this way, a reduction of the germs by the factor of 10⁷ is achieved as a whole. Additional influences such as for example the introduction of germs by way of the non-sterile air are not taken into consideration in these diagrammatic illustrations. One log unit is deducted here, and so a germ reduction of log 6 results as a whole. This value, however, is always still higher than the germ reduction with the aid of a conventional sterilizer. The reason is that in the suggested invention a physical method with a high degree of effectiveness is used in an inexpensive design. The proposed module advantageously does without cleaning and sterilization installations. As a result of dispensing with an external treatment with the second sterilization device 12 it would also be possible for the costs of a screening and also the costs of the individual radiators to be reduced.

The Applicants reserve the right to claim all the features disclosed in the application documents as being essential to the invention, insofar as they are novel either individually or in combination as compared with the prior art.

### LIST OF REFERENCES

4 shaping device
6 first sterilization device
8 filling device
10 plastics material pre-forms
12 second sterilization device
14 closing device
16 heating device
18 conveying device
20 plastics material containers
22 supply wheel
24 removal wheel
26 carrier
28 stressing devices
30 housing
32 radiation finger
34 gripping elements
35 clean room
36 carrier
38 third sterilization device
42 supply wheel
44 removal wheel
52 guide cam arranged in a stationary manner
L direction

1-12. (canceled)

13. A method for producing containers filled with liquids, and in particular with beverages, wherein plastics material pre-forms are heated by a heating device, are then conveyed to a shaping device and are shaped by this shaping device to form the plastics material containers, and, after that, the plastics material containers are conveyed to a filling device and are filled with the liquid, and wherein the containers are conveyed inside a clean room at least during the filling and are sterilized by a first sterilization device at least in part before the filling with the liquid inside the clean room, wherein the plastics material containers are pre-sterilized by a second sterilization device before the sterilization by the first sterilization device, wherein this pre-sterilization is carried out outside the clean room.

14. The method according to claim 13, wherein the pre-sterilization with the second sterilization device is carried out in such a way that an inner wall of the plastics material containers is acted upon with radiation and/or charge carriers.

15. The method according to claim 13, wherein the pre-sterilization with the second sterilization device is carried out after the heating with the heating device.

16. The method according to claim 13, wherein the plastics material containers are sterilized by the first sterilization device by being acted upon with a sterilization medium.

17. The method according to claim 13, wherein the plastics material pre-forms are pre-sterilized with the second sterilization device before and/or during the shaping procedure.

18. An apparatus for producing containers filled with liquid, with a heating device which heats plastics material pre-forms, with a shaping device which is arranged downstream of the heating device in a conveying direction of the plastics material pre-forms and which shapes plastics material pre-forms into plastics material containers, with a filling device which is arranged downstream of the shaping device in a conveying direction of the plastics material containers and which fills the containers with a liquid, with a clean room in which the containers are treated, and with a first sterilization device which is arranged at least in part upstream of the filling device and inside the clean room and which sterilizes the plastics material containers, wherein the apparatus has a second sterilization device which pre-sterilizes the plastics material containers, wherein this second sterilization device is situated outside the clean room.

19. The apparatus according to claim 18, wherein the second sterilization device is arranged upstream of the clean room in the conveying direction of the containers.

20. The apparatus according to claim 18, wherein the second sterilization device is arranged downstream of the heating device in the conveying direction of the containers.

21. The apparatus according to claim 18, wherein the second sterilization device has a stressing device which acts upon at least an inner wall of the plastics material pre-forms with charge carriers and/or an electromagnetic radiation.

22. The apparatus according to claim 18, wherein the second sterilization device has a movable carrier, on which are arranged a plurality of stressing devices which act upon at least an inner wall of the plastics material pre-forms with charge carriers and/or an electromagnetic radiation.

23. The apparatus according to claim 21, wherein the stressing device is movable with respect to the plastics material pre-forms in a direction which deviates from the conveying path of the plastics material pre-forms.

24. The apparatus according to claim 21, wherein at least one stressing device is capable of being inserted at least in sections through an aperture of the plastics material pre-forms.
